(19) United States
(12) Patent Application Publication
(10) Pub. No.: US 2026/0005982 A1
(43) Pub. Date: Jan. 1, 2026

(54) MANAGING LOW LATENCY LOW LOSS SCALABLE THROUGHPUT CAPABILITIES OF A UE FOR DATA TRANSMISSION

(71) Applicant: Samsung Electronics Co., Ltd., Suwon-si (KR)

(72) Inventors: Madhan Raj KANAGARATHINAM, Bangalore (IN); Jayendra Reddy KOVVURI, Bangalore (IN); Irlanki SANDEEP, Bangalore (IN); Jongmu CHOI, Suwon-si (KR); Junhak LIM, Suwon-si (KR)

(21) Appl. No.: 19/171,930

(22) Filed: Apr. 7, 2025

Related U.S. Application Data
(63) Continuation of application No. PCT/KR2025/002691, filed on Feb. 26, 2025.

(30) Foreign Application Priority Data
Jun. 27, 2024 (IN) 202441049266
Nov. 12, 2024 (IN) 2024 41049266

(51) Int. Cl. H04L 47/6295; H04W 72/566

(52) U.S. Cl. CPC H04L 47/6295; H04W 72/566

(57) ABSTRACT

A method for managing low latency low loss scalable throughput (L4S) capabilities of a user equipment (UE) for data transmission is provided. The method includes receiving, by the UE, data traffic generated by at least one application running on the UE (502), identifying predefined characteristics relating to the traffic generated by the at least one application, determining, by the UE, whether the data traffic generated by the at least one application is a low-queuing traffic (LQT) or a non-LQT traffic based on the predefined characteristics, assigning, by the UE, the LQT to a low-latency queue configured to a L4S queue of the UE, and assigning, by the UE, the non-LQT to a non-LAS queue of the UE for facilitating prioritized handling of the LQT during data transmission.

### CROSS-REFERENCE TO RELATED APPLICATION(S)

This application is a continuation application, claiming priority under 35 U.S.C. § 365 (c), of an International application No. PCT/KR2025/002691, filed on Feb. 26, 2025, which is based on and claims the benefit of an Indian Provisional patent application No. 202441049266, filed on Jun. 27, 2024, in the Indian Intellectual Property Office, and of an Indian Complete patent application No. 202441049266, filed on Nov. 12, 2024, in the Indian Intellectual Property Office, the disclosure of each of which is incorporated by reference herein in its entirety.

### FIELD OF INVENTION

The disclosure relates to wireless communication. More particularly, the disclosure relates to a method and system for managing low latency low loss scalable throughput (L4S) capabilities of a user equipment (UE) for data transmission.

### BACKGROUND OF INVENTION

The modern internet accommodates a variety of traffic types, each with distinct quality of service (QOS) needs. Traditionally, internet traffic can be categorized into two main types based on these QoS requirements. High-throughput applications, which rely on transmission control protocol (TCP)/quick user datagram protocol (UDP) Internet connections (QUIC) for dependable data transfers, prioritize Megabits per second (Mbps) as a key metric, often referred to as non-real time (NRT) traffic. Conversely, low latency real-time transfers, which utilize UDP and are essential for gaming and video calling applications, focus on milliseconds (ms) as the critical measure, indicating the time it takes for packets to reach the client. This type is known as real time (RT) traffic. In real-time applications, increased latency results in longer packet delivery times to the user equipment (UE), adversely affecting the perceived immediacy of these applications. Consequently, video calls may experience lag, and online gaming may suffer from delays between user inputs and the corresponding graphics displayed. Ultimately, high latency leads to a diminished Quality of Experience for users.

The delay or latency encountered by a data packet as it traverses the internet is influenced by multiple factors. These factors include the distance the packet must cover, known as propagation delay. Additionally, the data processing involved in the underlying communication technologies contributes to interface delay, which encompasses several time-consuming processes: aggregating data for bulk processing or burst transmission (aggregation delay), processing the data itself (processing delay), scheduling transmission opportunities on a shared medium (media acquisition delay), and finally transmitting the data over the medium (serialization delay). Furthermore, the number of routers or switches the packet encounters also plays a role, as data packets may experience idle time in buffers while waiting to be forwarded (queuing delay).

The growing need for real-time applications, including cloud gaming and virtual reality, introduces significant challenges in simultaneously managing network latency and throughput. Conventional congestion control methods, which mainly depend on packet loss as an indicator, fall short for contemporary applications that demand high throughput and extremely low latency. L4S is an innovative technology proposing adjustments to the foundational protocols to satisfy the QoS requirements for these types of traffic. Nevertheless, the uptake of L4S, especially among Android smartphones, is progressing slowly, with projections suggesting a timeline of around five years. This delay primarily stems from the integration of the Android network stack within the Linux kernel, necessitating that L4S capabilities be incorporated into the mainline Linux kernel first. Consequently, a challenge arises as the L4S stack introduces additional headers to packets, leading to increased processing delays and transmission overhead.

Real-time traffic with low bandwidth requirements constitutes a substantial segment of internet usage. This category primarily encompasses online gaming and video conferencing, both of which suffer from increased latency due to queuing delays at network bottlenecks. In contrast to the classic queue, the L4S queue effectively eliminates these queuing delays. While the L4S queue is optimized for scalable traffic, it permits a limited amount of non-L4S, unresponsive traffic to access the L4S queue, provided that the traffic rate remains sufficiently low to avoid congestion. However, some application developers may not be aware of the benefits that L4S offers. Currently, no real-time applications available in the Android marketplace take advantage of L4S capabilities. Furthermore, even when traffic is designated as L4S, the Internet protocol (IP) header markings can be modified by intermediary network devices.

The above information is presented as background information only to assist with an understanding of the disclosure. No determination has been made, and no assertion is made, as to whether any of the above might be applicable as prior art with regard to the disclosure.

### SUMMARY

In accordance with an aspect of the disclosure, a method for managing low latency low loss scalable throughput (L4S) capabilities of a user equipment (UE) for data transmission is provided. The method includes receiving, by the UE, data traffic generated by at least one application running on the UE, identifying, by the UE, predefined characteristics relating to the traffic generated by the at least one application, determining, by the UE, whether the data traffic generated by the at least one application is a low-queuing traffic (LQT) or a non-LQT traffic based on the predefined characteristics, assigning, by the UE, the LQT to a low-latency queue configured to a L4S queue of the UE, and assigning, by the UE, the non-LQT to a non-L4S queue of the UE for facilitating prioritized handling of the LQT during data transmission.

In an embodiment, the method includes prioritizing transmission of the LQT assigned to the L4S queue over the non-LQT assigned to the non-L4S queue.

In an embodiment, the LQT and the non-LQT are transmitted in accordance with accurate explicit congestion notification (AccECN) request for comments (RFC) specifications from egress points of the UE.

In an embodiment, the predefined characteristics relating to the data traffic comprises at least one of a past L4S history of the UE, a plurality of packet characteristics of packets received from the at least one application, an inter arrival time of the data traffic generated by the at least one application, a packet size of the data traffic, a packet bitrate of the data traffic, an incoming to outgoing ratio of the data traffic, or a layer 3 (L3)/layer 4 (L4) information including at least one of an Internet protocol (IP) addresses of the UE, ports of the UE, and protocols used by the UE.

In an embodiment, receiving, by a user equipment (UE), data traffic generated by at least one application running on the UE includes loading a pluggable L4S (pL4S) interface. The pL4S interface is implemented as an extended Berkeley Packet Filter (eBPF). In addition, the method includes capturing incoming packets corresponding to the data traffic from the at least one application at ingress points of the UE using the eBPF.

In an embodiment, determining, by the UE, whether the data traffic generated is the LQT or the non-LQT traffic based on the predefined characteristics includes setting explicit congestion notification (ECN) bits of an IP header of one or more data packets of the data traffic to 01 and flags of an Accurate ECN (ACE) Field to 111 to indicate support for AccECN. Further, the method includes determining whether at least one data packet of the plurality of data packets received support AccECN, in response to the ECN bits of the IP header of at least one data packet of the one or more data packets being set to 01 and the flags of the ACE being set to 111. In addition, the method includes performing one of classifying the at least one packet of the one or more packets as the LQT in response to AccECN being supported, and classifying the at least one packet of the one or more packet as the non-LQT in response to AccECN being not supported.

In an embodiment, the method includes storing values of the ECN bits of the IP header of at least one data packet of the one or more data packets received and the flags of the ACE in a hash map.

In an embodiment, the ACE corresponds to a counter that counts a number of Congestion Experienced (CE) packets within the data packets. For outgoing acknowledgment (ACK) packets, an ACE field within a Transmission Control Protocol (TCP) header of the ACK packet is modified in accordance with the CE packet count recorded in the hash map.

In an embodiment, determining, by the UE, whether the data traffic generated is the LQT or the non-LQT traffic based on the predefined characteristics includes detecting whether a user datagram protocol (UDP) connection with a bit rate of at least one data packet of the data traffic is less than a threshold. Further, the method includes performing a real-time machine learning (RT ML) detection on the data traffic, in response to the UDP with the bit rate being less than the threshold. The RT ML detection includes determining one or more parameters associated with the data traffic. Further, the RT ML detection includes determining whether the LQT or the non-LQT is detected based on an output of the RT ML detection model.

In accordance with aspect of the disclosure, a UE for managing low latency low loss scalable throughput (L4S) capabilities for data transmission is provided. The UE includes a processor, memory, a pluggable L4S (pL4S) interface, wherein the pL4S interface intercepts and manipulates packet flows of data traffic at the UE, and a pL4S throughput controller communicatively coupled to the processor and the memory, the pL4S throughput controller is configured to: receive data traffic generated by at least one application running on the UE, identify predefined characteristics relating to the traffic generated by the at least one application, determine whether the data traffic generated by the at least one application is a low-queuing traffic (LQT) or a non-LQT traffic based on the predefined characteristics, assign the LQT to a low-latency queue configured to a L4S queue of the UE, and assign the non-LQT to a non-LAS queue of the UE for facilitating prioritized handling of the LQT during data transmission.

In an embodiment, the pL4S throughput controller prioritizes transmission of the LQT assigned to the L4S queue over the non-LQT assigned to the non-L4S queue.

In an embodiment, the LQT and the non-LQT are transmitted in accordance with AccECN RFC specifications from egress points of the UE.

In an embodiment, the predefined characteristics relating to the data traffic comprises at least one of a past L4S history of the UE, a plurality of packet characteristics of packets received from the at least one application, an inter arrival time of the data traffic generated by the at least one application, a packet size of the data traffic, a packet bitrate of the data traffic, an incoming to outgoing ratio of the data traffic, or a L3/L4 information including at least one of an IP addresses of the UE, ports of the UE, or protocols used by the UE.

In an embodiment, the pL4S throughput controller loads the pluggable L4S (pL4S) interface. The pL4S interface is implemented as an extended Berkeley Packet Filter (eBPF). In addition, the pL4S throughput controller captures incoming packets corresponding to the data traffic from the at least one application at ingress points of the UE using the eBPF.

In an embodiment, pL4S throughput controller sets explicit congestion notification (ECN) bits of an IP header of one or more data packets of the data traffic to 01 and flags of an ACE to 111 to indicate support for AccECN. Further, the pL4S throughput controller determines whether at least one data packet of the plurality of data packets received support AccECN, in response to the ECN bits of the IP header of at least one data packet of the one or more data packets being set to 01 and the flags of the ACE being set to 111. In addition, the pL4S throughput controller performs one of classifies the at least one packet of the one or more packets as the LQT in response to AccECN being supported, and classifies the at least one packet of the one or more packet as the non-LQT in response to AccECN not being supported.

In an embodiment, the pL4S throughput controller stores values of the ECN bits of the IP header of at least one data packet of the one or more data packets received and the flags of the ACE in a hash map.

In an embodiment, the ACE corresponds to a counter that counts a number of Congestion Experienced (CE) packets within the data packets. For outgoing acknowledgment (ACK) packets, an ACE field within a Transmission Control Protocol (TCP) header of the ACK packet is modified in accordance with the CE packet count recorded in the hash map.

In an embodiment, pL4S throughput controller detects whether a user datagram protocol (UDP) connection with a bit rate of at least one data packet of the data traffic is less than a threshold. Further, the pL4S throughput controller performs a real-time machine learning (RT ML) detection on the data traffic, in response to the UDP with the bit rate being less than the threshold. The RT ML detection includes determining one or more parameters associated with the data traffic. Further, the RT ML detection includes determining whether the LQT or the non-LQT is detected based on an output of the RT ML detection model.

In accordance with an aspect of the disclosure, a non-transitory computer-readable storage medium storing one or more instructions, the one or more instructions, when executed by at least one processor, cause the at least one processor to perform the method of any combination of steps, operations, and/or functions described herein.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a block diagram that illustrates queuing delays according to the related art;

FIG. 2 is a block diagram that illustrates a L4S architecture according to the related art;

FIG. 3 is a schematic diagram that illustrates an IPV4 header and an IPV6 header according to the related art;

FIG. 4 is a block diagram that illustrates ECN and L4S support according to the related art;

FIG. 5 is a block diagram that illustrates a schematic of a UE implemented to carry out the disclosed subject matter according to an embodiment of the disclosure;

FIG. 6 is a schematic diagram that illustrates a high level design of the pluggable L4S (pL4S) according to an embodiment of the disclosure;

FIG. 7 is a schematic diagram that illustrates a negotiation between a sender and receiver for determining L4S traffic according to an embodiment of the disclosure;

FIG. 8 is a schematic diagram that illustrates data transfer between the sender and receiver for data packets belonging to an L4S-supported connection according to an embodiment of the disclosure;

FIG. 9 is a schematic diagram that illustrates forwarding RT traffic to a L4S queue according to an embodiment of the disclosure;

FIG. 10 is a schematic diagram that illustrates dynamically enabling the L4S for RT traffic according to an embodiment of the disclosure;

FIG. 11 is a schematic diagram that illustrates dynamically enabling the L4S for NRT traffic according to an embodiment of the disclosure;

FIG. 12A is a graphical diagram that illustrates a throughput with different round-trip times (RTTs) of a classic queue, L4S, and pL4S according to an embodiment of the disclosure;

FIG. 12B is a graphical diagram that illustrates a request completion time comparison of the classic queue, L4S, and pL4S according to an embodiment of the disclosure;

FIG. 12C is a graphical diagram that illustrates queueing delay comparisons between the classic queue, L4S, and pL4S according to an embodiment of the disclosure;

FIG. 13 is a graphical diagram that illustrates a comparison of the queueing delays between the classic queue, L4S, and pL4S according to an embodiment of the disclosure;

FIG. 14 is a graphical diagram that illustrates a throughput comparison between the classic queue, L4S, and pL4S according to an embodiment of the disclosure;

FIG. 15 is a schematic diagram that illustrates a use case of the pL4S for enabling next generation applications according to an embodiment of the disclosure;

FIG. 16 is a schematic diagram that illustrates a use case of the pL4S for enhancing existing real-time applications according to an embodiment of the disclosure; and

FIGS. 17A and 17B are flow diagrams that illustrates a method managing L4S capabilities of the UE for data transmission according to various embodiments of the disclosure.

The same reference numerals are used to represent the same elements throughout the drawing.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The various actions, acts, blocks, operations, or the like in the method is performed in the order presented, in a different order or simultaneously. Further, in some embodiments, some of the actions, acts, blocks, operations, or the like are omitted, added, modified, skipped, or the like without departing from the scope of the proposed method.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing (e.g. a processing circuitry) and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Aspects of the disclosure are to address at least the above-mentioned problems and/or disadvantages and to provide at least the advantages described below. Accordingly, an aspect of the disclosure may provide a method and system for managing L4S capabilities of a UE for data transmission.

One aspect of the disclosure may provide a pluggable implementation of the L4S receiver for electronic devices. The functionality is implemented as a separate extended Berkeley Packet Filter (eBPF) that augments the kernel without requiring any changes to kernel.

One aspect of the disclosure may automatically detect thin-streamed real-time app traffic in the bottleneck and direct the real-time traffic into the L4S queue, reducing the overall latency.

One aspect of the disclosure may dynamically update identified low-queuing traffic (LQT) traffic to L4S queues in devices with at least two independent queues for traffic management.

Additional aspects will be set forth in part in the description which follows and, in part, will be apparent from the description, or may be learned by practice of the presented embodiments.

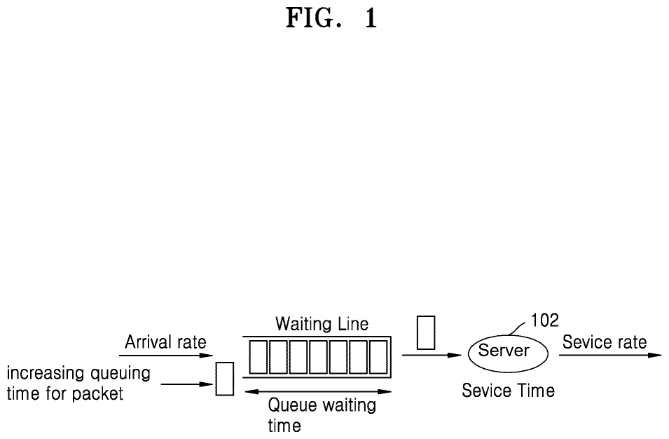

FIG. 1 is a block diagram that illustrates queuing delays according to the related art.

Referring to FIG. 1, the block diagram includes a server (102) that monitors a service time of the queue (e.g., a waiting line). The service time refers to a difference between a completion time and a starting time. Based on the service time determined, the server (102) determines a service rate. The service rate refers to a number of customers/users that may be served per time period (for example, per hour, per day, per minute, etc.). The primary contributor to latency, which negatively impacts user experience, is queueing delay. This delay occurs when packets remain stationary in queues and buffers prior to being transmitted. As a result, applications may suffer from diminished visual quality, including issues such as poor latency, jitter, buffering, and low video resolution.

Active Queue Management (AQM) is a technique employed to control queue sizes and avert buffer overflows by proactively discarding packets before the buffer reaches capacity. AQM aims to keep queue occupancy close to a predetermined target, which can be based on either queue size or queuing delay. Notable examples of widely implemented AQM methods in network routers include proportional integral controller enhanced (PIE) and random early detection (RED). Despite the use of AQM, traffic can still experience considerable jitter. Quality of Service (QOS) settings enable the prioritization of specific traffic types over others; for instance, prioritizing real-time communication over less critical background tasks. This prioritization may lead to diminished performance in other traffic areas. Additionally, intelligent solutions (such as the Application Prioritization Engine (APE) and Smart Hotspot) enhance latency for real-time applications in the foreground, though at the cost of limiting bandwidth for background traffic.

Traffic that seeks to optimize capacity, such as downloads, assesses the bottleneck bandwidth along the transmission path and adjusts its sending rate—defined as the rate at which data packets are transmitted—to prevent congestion at the bottleneck. The Congestion Control mechanism (CC) regulates this sending rate to alleviate potential bottlenecks occurring at devices like routers. When the sending rate exceeds the capacity, a queue begins to develop at the bottleneck router, leading to increased queuing delays and, consequently, higher End-to-End latency. The predominant congestion control methods in use today are CC techniques. These techniques rely on packet loss as an indicator of network congestion. When the size of the queue exceeds the buffer capacity, packets are discarded. This loss prompts the sender to decrease its transmission rate. However, by the time the sender responds, a queue has already developed, leading to heightened delays for the packets that follow.

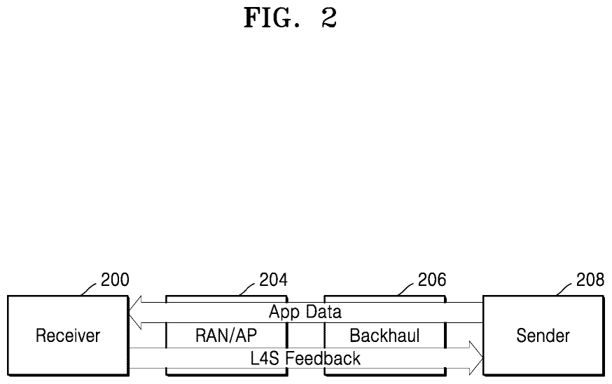

FIG. 2 is a block diagram that illustrates a L4S architecture according to the related art.

Referring to FIG. 2, the block diagram includes a receiver (202), a radio access network (RAN)/access point (AP) (204), a backhaul (206), and a sender (208). The RAN/AP (204) (also referred to as a bottleneck router), maintains separate queues for L4S and Classic traffic. The RAN/AP (204) marks the L4S packets to indicate congestion, as soon as the L4S queue starts to build-up. The receiver (202) provides congestion feedback to the sender (208) based on the bottleneck packet markings. The sender (208) uses scalable congestion control and adjusts the sending rate based on the feedback from the receiver (202).

L4S offers numerous applications that enhance the performance of applications utilizing Real-Time Traffic. It significantly reduces latency for real-time gaming and enhances the responsiveness of gaming interfaces. One of its most effective applications is in improving video quality and minimizing packet loss for online meeting platforms.

The request of a request for comments (RFC) regarding L4S has not led to significant progress in its adoption and commercialization. The existing L4S architecture necessitates modifications across all networking elements, including the sender (208), intermediary network devices, and the receiver (202). Each component must be capable of interpreting the L4S protocol; otherwise, the advantages of L4S are effectively rendered moot. Modifications are required within the Linux kernel, but these changes have not yet been incorporated into the mainline. Current projections suggest that it may take over five years for devices to achieve L4S capability.

The L4S is integrated into the TCP/IP stack. This integration involves adding headers to all packets, which results in unnecessary overhead. Not every packet needs to utilize L4S. According to current standards, traffic marked with the L4S header is directed to the L4S queue (designated for low latency), while unmarked packets are routed to the standard queue. It is important to note that LQT packets may not carry the L4S marking, as this is a new standard. Consequently, these LQT packets will be sent to the regular queue, experiencing queuing delays despite being intended for the L4S queue. Additionally, there is a risk that certain applications may exploit the L4S header to gain priority. For instance, some gambling applications might falsely label their traffic as L4S, allowing their data packets to be prioritized in the L4S queue.

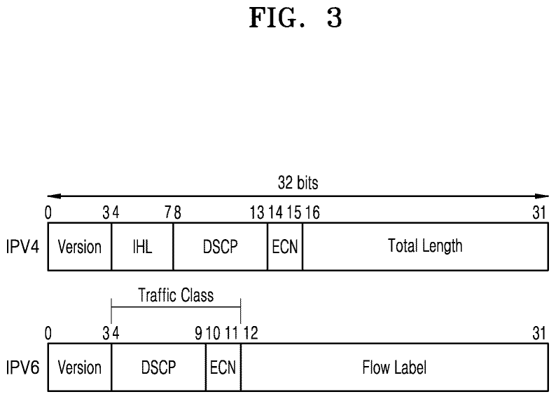

FIG. 3 is a schematic diagram that illustrates an IPV4 header and an IPV6 header according to the related art.

ECN bits serve to inform network routers whether the traffic is classified as L4S or traditional queue. In both the IPV4 and IPV6 headers, the ECN protocol utilizes the two bits that follow the differentiated services code point (DSCP) value. The ECN bits allow 4 combinations of ECN code points and the details are presented in the table below.

| Bits | ECN Code Point | Traffic Type |
|---|---|---|
| 00 | Not ECT | Not ECN capable transport |
| 10 | ECT (0) | Classic ECN capable transport |
| 01 | ECT (1) | L4S capable transport |
| 11 | CE | Congestion Experienced |

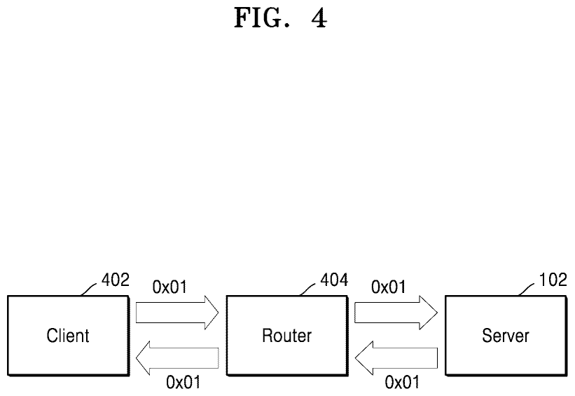

FIG. 4 is a block diagram that illustrates ECN and L4S support according to the related art.

Referring to FIG. 4, the block diagram includes a client (402), a router (404), and the server (102). The L4S traffic from the client (402) and the server (102) should be marked as ECT (1) to indicate that the traffic is LAS traffic.

The proposed solution discloses methods and systems for managing L4S capabilities in user equipment (UE) for data transmission. It introduces a modular implementation of the L4S receiver tailored for electronic devices. This functionality is delivered as a standalone eBPF that enhances the kernel without necessitating modifications to it. Real-time application traffic that is thin-streamed is automatically recognized at the bottleneck. This real-time traffic is then routed into the L4S queue, which helps to minimize overall latency. The identified LQT traffic is dynamically adjusted to L4S queues in devices that possess at least two independent queues for effective traffic management.

The proposed solution provides an immediate and deployable method that facilitates L4S functionality across a range of devices, including those operating on older kernel versions. This strategy bypasses the lengthy kernel update process, thereby expediting the integration of L4S features and improving the performance of latency-sensitive applications on a wide scale. The solution outlines how the packet classifier designates traffic as either L4S or classic. Subsequently, two separate queues are established: one for L4S traffic and another for classic traffic. The scheduler prioritizes L4S packets, processing them before other types of packets. In this solution, real-time packets are identified by activating the ECN bits in the IP header, allowing for differentiation from other traffic packets.

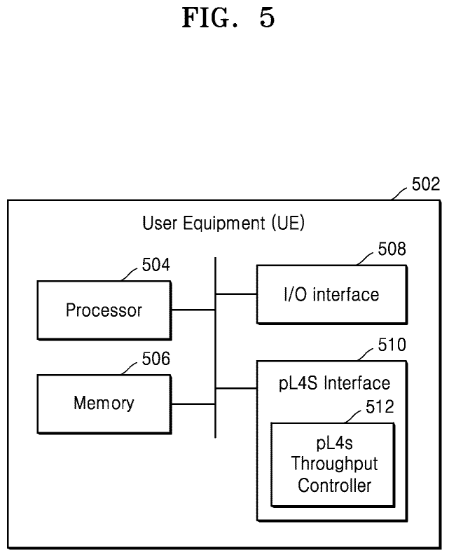

Referring now to the drawings, and more particularly to FIGS. 5 through 11, 12A, 12B, 12C, 13-16, 17A, and 17B, where similar reference characters denote corresponding features consistently throughout the figures, there are shown preferred embodiments.

FIG. 5 is a block diagram that illustrates a schematic of a UE (502) implemented to carry out the disclosed subject matter according to an embodiment of the disclosure.

For instance, the UE (502) may include, but not limited to a smartphone, a tablet, a laptop, a personal computer (PC), a television, a connected car, an Internet of things (IoT) device, and the like. As shown, the UE (502) includes a processor (504), memory (506), an input/output (I/O) interface (508), a pluggable L4S (pL4S) interface (510) implemented on an L4S receiver, and a pL4S throughput controller (512) communicatively coupled to the processor (504) and the memory (506). Each component is explained in further detail below.

The processor (504) communicates with the memory (506), the I/O interface (508) and the pL4S throughput controller (512). The processor (504) is configured to execute instructions stored in the memory (506) and to perform various processes. The processor (504) may include one or a plurality of processors. The processor (504) may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The memory (506) includes storage locations to be addressable through the processor (504). The memory (506) is not limited to volatile memory and/or non-volatile memory. Further, the memory (506) may include a plurality of computer-readable storage media. The memory (506) may include non-volatile storage elements. For example, non-volatile storage elements may include magnetic hard discs, optical discs, floppy discs, flash memories, or forms of electrically programmable read only memories (EPROM) or electrically erasable and programmable ROM (EEPROM) . . .

In an embodiment, the memory (506) may store one or more instructions. When executed by the processor (504) and/or other processor(s) included in the UE (502) individually or collectively, the one or more instructions may cause the UE (502) to perform any combination of operations, functionalities, and/or steps in accordance with the present disclosure.

The I/O interface (508) transmits the information between the memory (506) and external peripheral devices. The peripheral devices are the input-output devices associated with the UE (502). Further, the pL4S throughput controller (512) communicates with the I/O interface (508) and the memory (506). The pL4S throughput controller (512) may be communicatively coupled to the memory (506) and the processor (504). The pL4S throughput controller (512) is an innovative hardware that is realized through the physical implementation of both analog and digital circuits, including logic gates, integrated circuits, microprocessors, microcontrollers, memory circuits, passive and active electronic components, as well as optical components.

In an embodiment, the pL4S throughput controller (512) receives data traffic generated by at least one application running on the UE (502). For example, the applications running on the UE (502) may include, but not limited to a cloud gaming application, a virtual reality (VR)/extended reality (XR) service, online gaming, video calling, and the like. Data traffic refers to the flow of data across a network, such as the internet or a private network. Data traffic is generally measured in units of data volume (such as bits, bytes) over time and may vary depending on the type of activity, the number of users, the speed of the data connection, and the like. Managing data traffic is important for network performance to avoid slowdowns, dropped connections, and congestions.

In an embodiment, the pL4S throughput controller (512) loads the pL4S interface (510). The pL4S interface (510) may implemented on (or implemented as) an L4S receiver. For instance, the pL4S interface (510) is implemented as an extended Berkeley Packet Filter (eBPF). Accordingly, the implementation of the Pl4S interface (510) may not require modifications to a kernel of the UE (502). L4S is widely discussed in the Internet engineering task force (IETF) and 3rd generation partnership project (3GPP) standards. The eBPF refers to a technology that allows functions to run in the kernel without modifications in the source code or without the addition of additional/new components. The eBPF is capable in regulating data packets in real-time, due to which it is useful in network analysis, security enforcement, and data traffic control.

In an embodiment, the pL4S throughput controller (512) captures incoming packets corresponding to the data traffic from the application(s) at ingress points of the UE (502) using the eBPF. This thereby enables congestion feedback and protocol negotiation directly from a data plane of the UE (502). The ingress points refer to locations or interfaces through which the packets enter into the UE (502). The ingress points are crucial for handling the data traffic and ensures seamless connectivity in the wireless network.

In an embodiment, the pL4S throughput controller (512) identifies (or determines) predefined characteristics relating to the data traffic generated by the application(s). For instance, the predefined characteristics relating to the data traffic includes a past L4S history of the UE (502), packet characteristics of packets received from the application(s), an inter arrival time of the data traffic generated by the application(s), a packet size of the data traffic, a packet bitrate of the data traffic, an incoming to outgoing ratio of the data traffic, and a L3/L4 information. The L3/L4 information includes an IP addresses of the UE (502), ports of the UE (502), and protocols used by the UE (502).

The past L4S history of the UE (502) relates to an interaction between the UE (502) and an L4S enabled network. For instance, the past L4S history may include information about previous L4S network conditions, such as a latency, packet loss, and throughput experienced by the UE (502). The packet characteristics refer to the features or attributes of the data packets being transmitted by the UE (502). For instance, the packet characteristics may include information such as packet size, the data type, priority level of the data, and the like. The inter-arrival time of the data traffic refers to a time difference between the arrival of consecutive data packets. Monitoring the inter-arrival time is crucial as it impacts latency and jitter.

The packet size of the data traffic refers to an amount of data (represented in bytes) carried in each data packet. In L4S, the packet size may impact congestion control, latency, and overall throughput. The packet bitrate of the data traffic refers to the rate (represented in bits per second (bps)) at which the data packets are transmitted from the UE (502). The packet bitrate influences the bandwidth required by the UE (502) and effects network congestion. The incoming to outgoing ratio refers to a ratio between an amount of incoming data traffic received by the UE (502) and outgoing traffic sent by the UE (502). This ratio is important for traffic shaping and ensuring a quality of service (QOS).

The L3 (layer 3-network layer) information includes information about IP addresses routing, and packet forwarding. The L3 information manages data transfer from one node to another node over different networks. The L4 (layer 4-transport layer) information includes information about transport protocols, such as transmission control protocol (TCP), user datagram protocol (UDP), and the like. The L4 ensures reliable data transmission, flow control, and congestion control. The L3 information and L4 information collectively determine how well the UE (502) performs in an L4S-enabled network. This impacts how the data traffic is transmitted, managed, and optimized to achieve the goals of low latency, minimal packet loss, and high scalability.

In an embodiment, the pL4S throughput controller (512) determines whether the data traffic generated by the application(s) is a low-queuing traffic (LQT) or a non-LQT based on the predefined characteristics. LQT refers to data traffic that is sensitive to latency and queuing delays. LQT is important for applications that require real-time communication or very low latency, such as voice over IP (VOIP), online gaming, video conferencing, and the like. Non-LQT refers to data traffic that is less sensitive to latency and queuing delays. Non-LQT may tolerate queuing and higher delays without significant performance degradations. Identifying the data traffic as LQT or non-LQT is fundamental to achieving the low-latency, low-loss, and scalable throughput of the L4S.

In an embodiment, the pL4S throughput controller (512) sets explicit congestion notification (ECN) bits of the IP header (for example, IPV4, IPV6) of the data packets of the data traffic to 01 and flags of an ACE to 111 to indicate support for accurate explicit congestion notification (AccECN). The ACE is a 3 bit counter (0-8) that counts the number of Congestion Experienced (CE) packets within the data packets. With the help of the ACE, the sending rate may be duly adjusted to avoid queue built-up. The AccECN is important for the L4S, where low-latency and scalable throughput are important. The accurate feedback/support from the AccECN enables maintaining low queuing delays and avoiding network congestion. This thus allows the L4S to meet its performance goals.

In an embodiment, the pL4S throughput controller (512) determines whether the data packet(s) received support AccECN. This determination is performed in response to the ECN bits of the IP header of the data packet(s) being set to 01 and the flags of the ACE being set to 111. The pL4S throughput controller (512) classifies the data packet(s) as the LQT in response to the AccECN being supported (e.g., by the pL4S throughput controller (512) or other components of UE (502)) and as the non-LQT in response to the AccECN not being supported (e.g., by the pL4S throughput controller (512) or other components of UE (502)).

In an embodiment, the pL4S throughput controller (512) stores values of the ECN bits of the IP header of the data packet(s) received and the flags of the ACE in a hash map. The hash map stores these values as key-value pairs, where the values may be added, retrieved, and deleted using the keys. Storing the data/values as key value pairs enables quick retrieval without relying on additional or other sources.

In an embodiment, the pL4S throughput controller (512) detects whether the UDP connection with a bit rate of the data packet(s) of the data traffic is less than a threshold. The UDP connection is a connectionless protocol that does not establish a formal connection between the UE (502) and the receiver (202). It sends the data packets (datagrams) to the receiver (202) without ensuring that they arrive in a particular order.

In an embodiment, the pL4S throughput controller (512) performs a real-time machine learning (RT ML) detection on the data traffic when the UDP with the bit rate is less than the threshold. The RT ML detection refers to a process of analyzing the data traffic in real-time to detect patterns, anomalies, or certain behaviors as data is transmitted to/from the UE (502). The RT ML is capable of handling large amounts of data traffic, making it useful for environments like cloud networks or large enterprises.

In an embodiment, the pL4S throughput controller (512) determines one or more parameters associated with the data traffic. The one or more parameters are provided as inputs to train a RT ML detection model. For instance, the one or more parameters include an average inter-arrival time (IAT), a maximum IAT, a packet count, an average packet size, a minimum packet size, and a maximum packet size in uplink and downlink directions. In the proposed solution, the RT detector service operates at the framework layer, utilizing an AI/ML-driven intelligent solution to forecast traffic as either real-time or non-real time through machine learning techniques.

The average IAT refers to an average time interval between consecutive data packets arriving at a specific point in the L4S. The average IAT helps in providing insights in the data traffic flow and identifying congestions. The maximum IAT refers to a longest time interval observed between two consecutive data packets. The maximum IAT helps in indicating periods of low traffic or potential issues in the L4S. The packet count refers to the total number of packets transmitted in either the uplink direction or downlink direction over a specific time period.

The average packet size refers to a mean size of packets transmitted during a specific time period. The average packet size helps in determining a nature of the data traffic. The minimum packet size refers to the smallest packet size recorded. This may indicate the presence of small control packets or headers. The maximum packet size refers to the largest packet size recorded. This may indicate large data transfers, such as file uploads or video streaming. The pL4S throughput controller (512) then determines whether the LQT or the non-LQT is detected based on an output of the RT ML detection model.

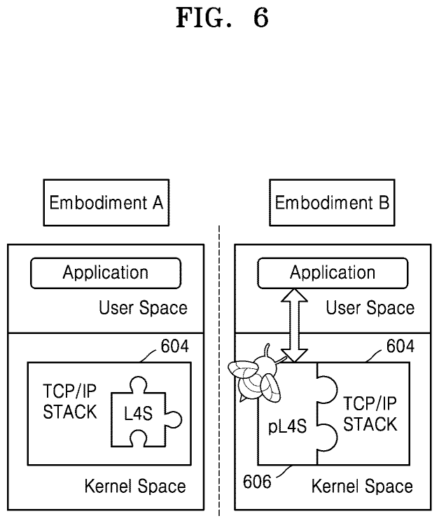

FIG. 6 is a schematic diagram that illustrates a high level design of the pluggable L4S (pL4S) (606) according to an embodiment of the disclosure.

In an ‘embodiment A’ illustrated in FIG. 6, the L4S utilized by the application is embedded within the TCP/IP stack (604). This integration could result in a prolonged timeline for the L4S deployment, potentially extending to approximately five years. In an ‘embodiment B’ illustrated in FIG. 6, the embodiment B involves implementing the pL4S (606) as a distinct component using eBPF, which can be integrated into the TCP/IP stack (604) as required. This allows the UE (502) to benefit from the low latency advantages offered by L4S. To achieve a pluggable design for the pL4S (606), two separate EPFs are utilized. These EPFs consist of an ingress handler and an egress handler. The ingress handler is connected to the ingress path of the UE (502) and is responsible for examining incoming packets while updating congestion statistics. Conversely, the egress handler is linked to the egress path of the UE (502) and is tasked with altering outgoing packets to facilitate appropriate negotiation and feedback signaling in accordance with AccECN RFC specifications.

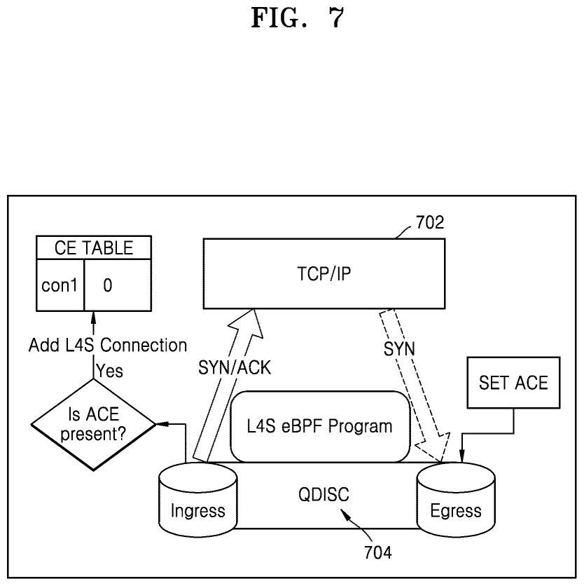

FIG. 7 is a schematic diagram that illustrates a negotiation between the sender (208) and the receiver (202) for determining L4S traffic according to an embodiment of the disclosure.

The schematic diagram includes a TCP/IP (702) and a queuing discipline (QDISC) (704). The TCP/IP (702), also known as an internet protocol suite, is a set of communication protocols used for transmitting data packets over wireless networks. The TCP/IP (702) defines how the data is sent, routed, and received within the wireless network. The QDISC (704) manages network traffic, queuing, and scheduling. The QDISC (704) organizes the data packets into queues and decides which data packet(s) to transmit next.

During the transmission of the synchronize (SYN) packet, the egress configures the ACE flags to 111 and sets the IP ECN to 01, thereby indicating its support for AccECN. This adjustment informs the sender (208) of the capabilities of the receiver (202). When the ingress receives a SYN/acknowledgment (ACK) packet, it verifies the ACE fields to confirm the support of the sender (208) for AccECN. If the fields are correctly configured (indicating that the sender (208) supports AccECN), the connection details, including destination IP/port and source IP/port, are stored in the hash map allocated for L4S-supported connections. The final acknowledgment in the three-way handshake is dispatched with the ACE flags aligned with the AccECN specification, completing the setup for AccECN communication.

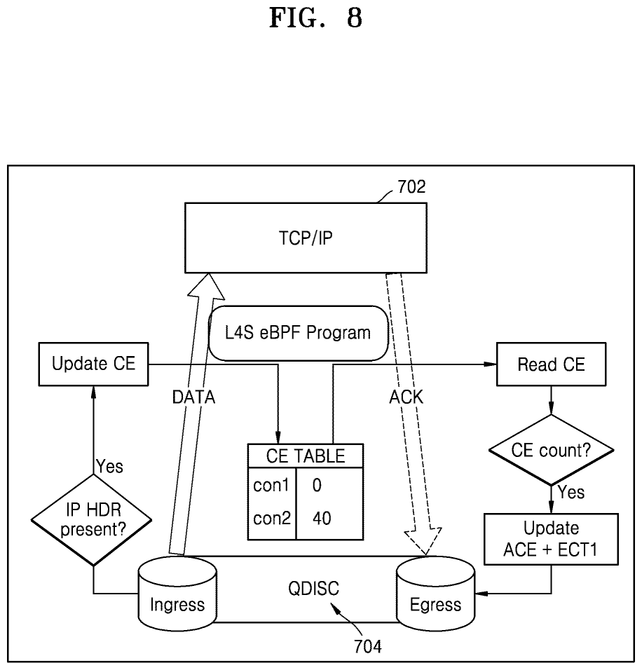

FIG. 8 is a schematic diagram that illustrates data transfer between the sender (208) and the receiver (202) for data packets belonging to an LAS-supported connection according to an embodiment of the disclosure.

Each incoming packet associated with an L4S-supported connection undergoes inspection. The hash map is updated with packet and byte counters based on the ECN marks found in the packet (CE, ECT (0), or ECT (1)). For outgoing ACK packets, the IP ECN fields are configured to 01. The ACE field within the TCP header is modified in accordance with the CE packet count recorded in the hash map. Additionally, byte counters may be included in the TCP options field of the ACK packet to offer more detailed feedback, although this is not essential for fundamental AccECN operations.

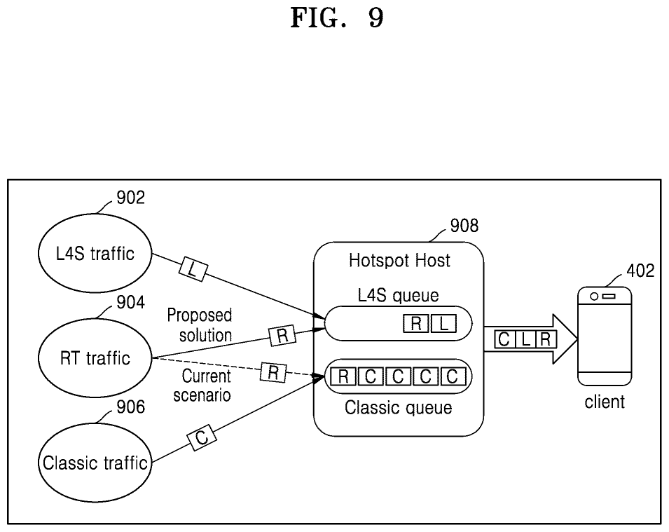

FIG. 9 is a schematic diagram that illustrates forwarding RT traffic to a LAS queue according to an embodiment of the disclosure.

Referring to FIG. 9, the schematic diagram includes a L4S traffic (902), a real-time (RT) traffic (904), a classic traffic (906), a hotspot host (908), and the client (402). The L4S traffic (902) refers to traffic designed to achieve low latency, low loss, and scalable throughput in congested networks. The RT traffic (904) refers to traffic that has stringent requirements for low latency and low jitter. The classic traffic (906) refers to traffic that is handled using TCP congestion control mechanisms.

In the present situation, the Real-time (RT) traffic (904) is directed to the Classic queue, resulting in increased queuing delays and overall latency for Real-time traffic. The proposed solution involves marking the real-time packets by configuring the ECN bits in the IP header to 0x01. We employ pL4S (606) to facilitate the selective marking of these packets. This process effectively transitions the traffic from the Classic service to the L4S service, thereby minimizing queuing delays. The proposed solution is applicable across all bottlenecks, including cellular networks (eNB, gNB) and Wi-Fi access points (AP).

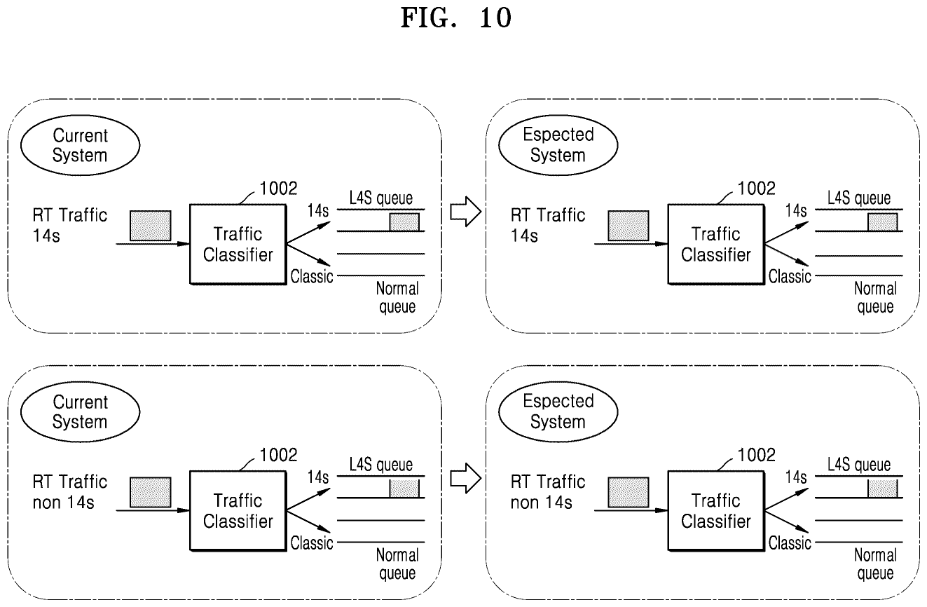

FIG. 10 is a schematic diagram that illustrates dynamically enabling the L4S for RT traffic according to an embodiment of the disclosure.

Referring to FIG. 10, a data packet of a RT traffic of 14 seconds and a RT traffic of non-14 seconds is passed to a traffic classifier (1002). The traffic classifier (1002) identifies and categorizes the data traffic based on specific criteria, such as the type of the application, protocol, source IP address, destination IP address, port number, packet size, and the like. In the current and expected systems, the data packet having a RT traffic of 14 seconds is placed in the L4S queue. For RT traffic of non-14 seconds, the data packet is placed in the normal queue in the current system and in the L4S queue in the expected system.

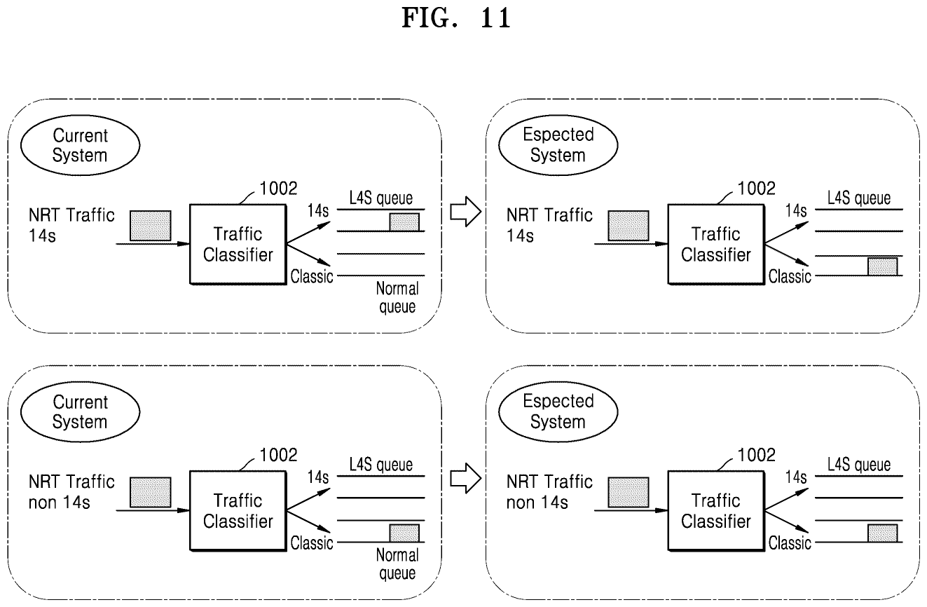

FIG. 11 is a schematic diagram that illustrates dynamically enabling the L4S for NRT traffic according to an embodiment of the disclosure.

Referring to FIG. 11, a data packet of a NRT traffic of 14 seconds and a NRT traffic of non-14 seconds is passed to a traffic classifier (1002). The traffic classifier (1002) identifies and categorizes the data traffic. For NRT traffic of 14 seconds, the data packet is placed in the L4S queue in the current system and in the normal queue in the expected system. For NRT traffic of non-14 seconds, the data packet is placed in the normal queue both the current system and the expected system.

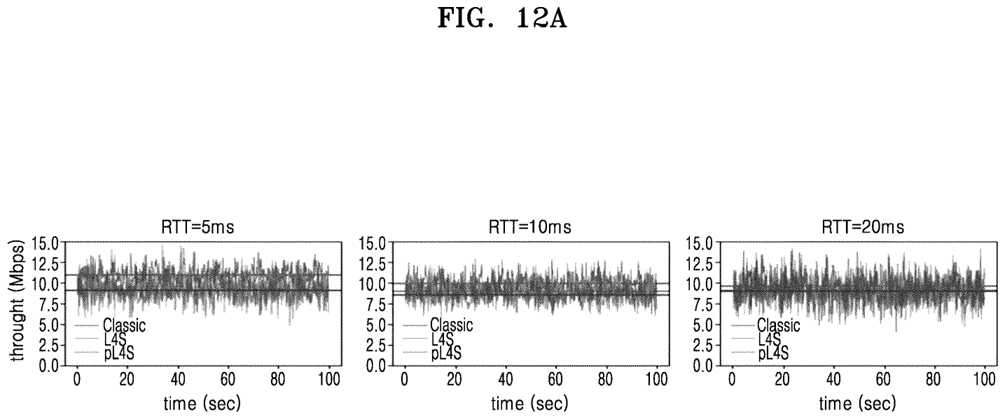

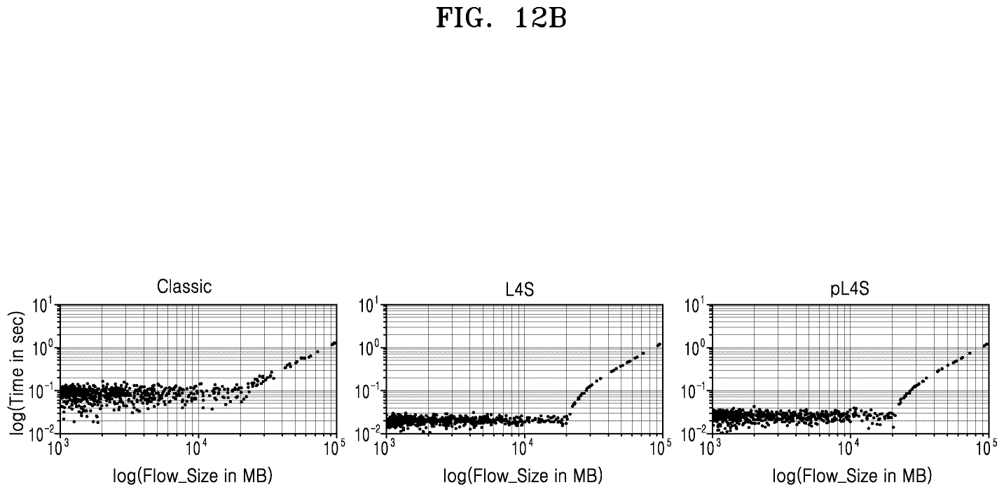

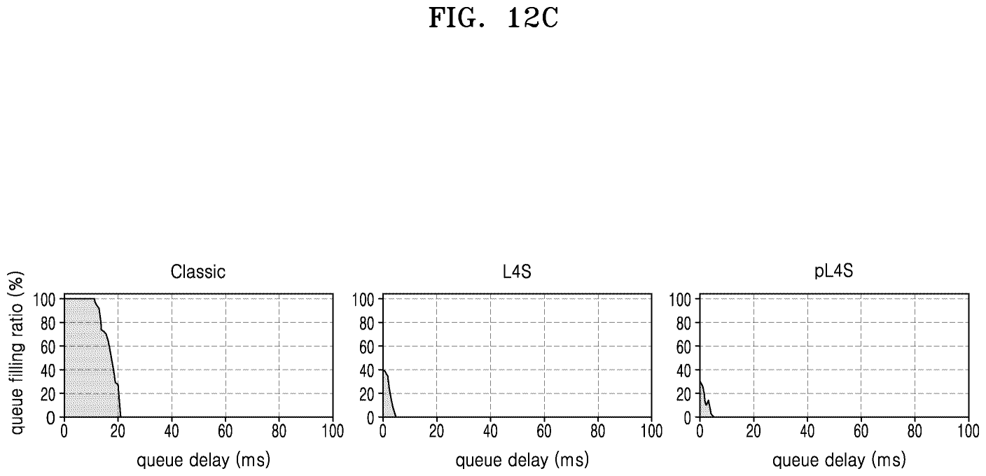

FIG. 12A is a graphical diagram that illustrates a throughput with different RTTs of a classic queue, L4S, and the pL4S (606) according to an embodiment of the disclosure.

FIG. 12B is a graphical diagram that illustrates a request completion time comparison of the classic queue, L4S, and the pL4S (606) according to an embodiment of the disclosure.

FIG. 12C is a graphical diagram that illustrates queueing delay comparisons between the classic queue, L4S, and the pL4S (606) according to an embodiment of the disclosure.

The configuration of the virtual machine testing environment draws inspiration from the L4STeam/L4Sdemo GitHub repository. A total of seven virtual machines have been set up on an HP Linux server: two are designated as clients for L4S and the pL4S (606), two function as scalable servers for L4S and the pL4S (606), two are allocated for traditional client-server interactions, and one serves as an Active Queue Management (AQM) node. The classic server and client utilize the Cubic congestion control procedures. The scalable servers and L4S client operate on a kernel that includes the L4S patch. The pL4S (606) employs Cubic as well, but it is augmented with two eBPF programs that are integrated at the interface's ingress and egress points using traffic control (tc). A bottleneck of 30 Mbps is established at the network hop on the interface directed towards the clients, and the dualpi2 scheduler is implemented with its default settings. Additionally, a controlled delay is introduced to replicate various round-trip time (RTT) effects on the outcomes.

Testing was conducted with simultaneous download sessions from all three servers to their respective clients, utilizing round-trip times (RTTs) of 5 ms, 10 ms, and 20 ms. Referring to FIGS. 12A, 12B, and 12C, both L4S and the pL4S (606) demonstrate nearly equivalent throughput across all RTTs. Classic traffic achieves the fair rate of 10 Mbps, while L4S and the pL4S (606) show a slight underperformance. Following this, repeated hypertext transfer protocol (HTTP) requests were executed from all clients to their corresponding servers, revealing that both L4S and the pL4S (606) result in shorter completion times (including connection setup and data transfer) compared to classic traffic. Queue-filling ratios and delays were observed in the Active Queue Management (AQM) node under two distinct scenarios: classic versus L4S and classic versus the pL4S (606). FIGS. 12A, 12B, and 12C provide snapshots of the queue ratios and delays recorded during the tests. The pL4S (606) demonstrates queue management efficiency comparable to that of L4S. In conclusion, the tests conducted on the Linux virtual machine validate that the pL4S (606) closely replicates the performance of L4S, offering low latency advantages while maintaining throughput levels similar to those of classical traffic.

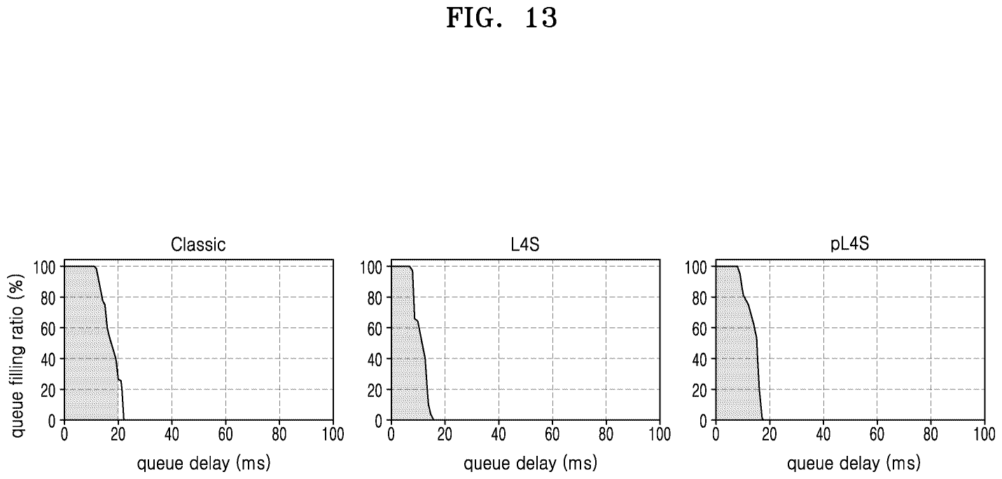

FIG. 13 is a graphical diagram that illustrates a comparison of the queueing delays between the classic queue, L4S, and the pL4S (606) according to an embodiment of the disclosure.

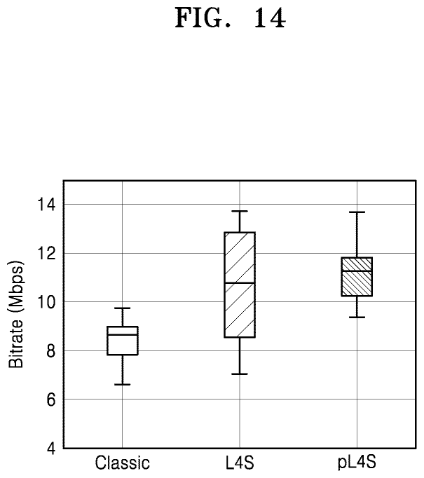

FIG. 14 is a graphical diagram that illustrates a throughput comparison between the classic queue, L4S, and the pL4S (606) according to an embodiment of the disclosure.

Tests were performed in a real-world setting using a server that implements BBR2 congestion control. The traditional client lacks support for AccECN, while the L4S client integrates AccECN directly into the kernel, based on the kernel patch available from the L4Slinuxpatch GitHub repository. In contrast, the pL4S client operates on the same kernel as the traditional client but utilizes a user-space application to load the eBPF programs of the pL4S (606). An electronic device, set up to act as a hotspot, is outfitted with the dualpi2 qdisc module, which is then linked to the device's softAP interface. This Mobile Hotspot device can achieve download speeds exceeding 100 Mbps, making the wireless connection between the Hotspot host and its clients the main limiting factor. The hotspot host is located approximately 8 meters away from the clients, resulting in a combined download speed of 20-30 Mbps for all connected clients.

A download throughput test was performed over 25 rounds, with the results illustrated in FIG. 13. The throughput achieved by both L4S and pL4S clients consistently exceeded that of traditional traffic by as much as 18%. While improvements in queue delay were noted, they were not as significant as those observed in VM testing, reflecting a modest enhancement of 3-4%, as shown in FIG. 13. Throughout the assessments, the pL4S (606) yielded results that were identical to those of L4S, confirming the solution's ability to provide the expected low latency advantages. These advantages may be more pronounced in real-world scenarios than in simulations. It is important to note that all tests utilized the default dualpi2 parameters, indicating the possibility of further latency reductions through optimization.

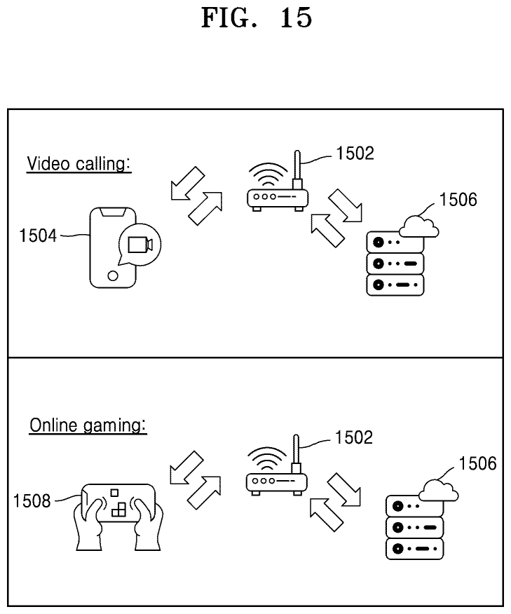

FIG. 15 is a schematic diagram that illustrates a use case of the pL4S (606) for enabling next generation applications according to an embodiment of the disclosure.

For instance, the use case shown corresponds to video calling and online gaming. In the video calling, a bottleneck router (1502) is in communication with a user device (1504) and a cloud server (1506). For example, the bottleneck router (1502) may include a gNB, Wi-Fi, hotspot, and the like. The user initiates a video call through an application on the user device (1504). By default, video calling is categorized as classic traffic, which results in increased latency. Consequently, the frame rate and resolution of the video calls diminish, leading to a choppy experience. In the proposed solution, we enhance the video calling traffic by upgrading it to the L4S queue, which offers nearly zero queuing delay. This upgrade significantly improves the clarity of the video call and enhances overall call quality.

In the online gaming, the bottleneck router (1502) is in communication with a gaming device (1508) and the cloud server (1506). At present, RT gaming is categorized as classic traffic by default, resulting in heightened overall latency. This leads to frame drops and delays in actions, causing a laggy gaming experience. The proposed solution involves upgrading the gaming traffic to the L4S queue, which offers nearly zero queuing delay. As a result, the gaming experience becomes smooth and free of delays.

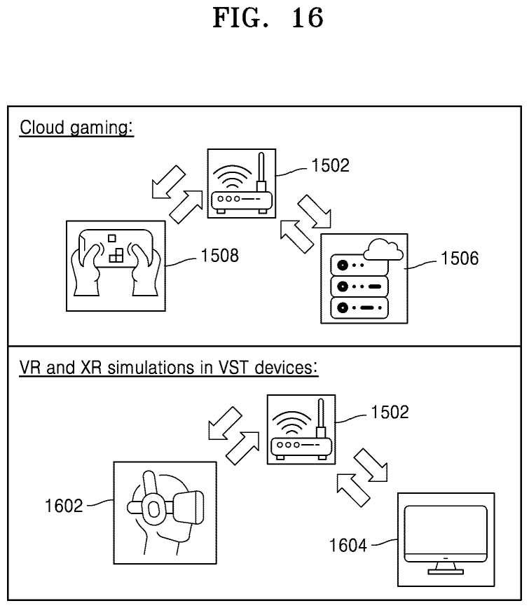

FIG. 16 is a schematic diagram that illustrates a use case of the pL4S (606) for enhancing existing real-time applications according to an embodiment of the disclosure.

For instance, the use case corresponds to cloud gaming and VR/XR simulations. In the cloud gaming, the bottleneck router (1502) is in communication with the gaming device (1508) and the cloud server (1506). The user initiates the cloud gaming application on the gaming device (1508). At present, while the cloud server (1506) is compatible with L4S, the gaming device (1508) lacks support for it. This results in frame drops and action delays, leading to a laggy gaming experience. In the proposed solution, the gaming device (1508) gains the ability to support the receiver L4S functionality. Consequently, the gameplay becomes seamless, with no noticeable delays.

In the VR/XR simulations, the bottleneck router (1502) is in communication with a Video See Through (VST) device (1602) and a display (1604). The user initiates a VR/XR service, utilizing a dedicated server for processing. At present, while the server is compatible with L4S, the VST device (1602) lacks support for this feature. This results in frame drops and action delays. The proposed solution enables the VST device (1602) to immediately support receiver L4S functionality. Consequently, the VR/XR experience becomes immersive and operates in real time, free from delays.

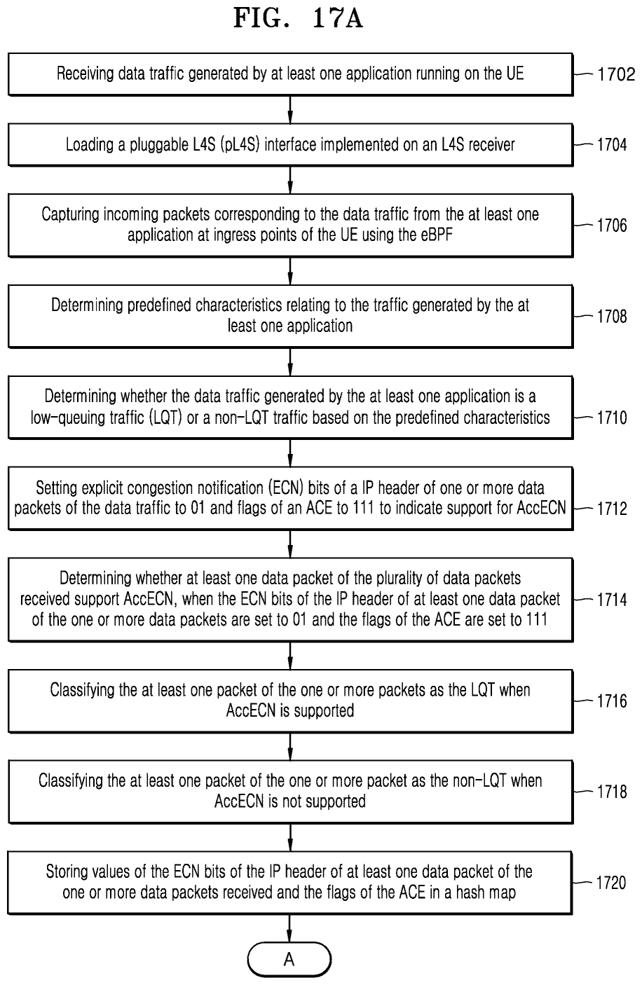

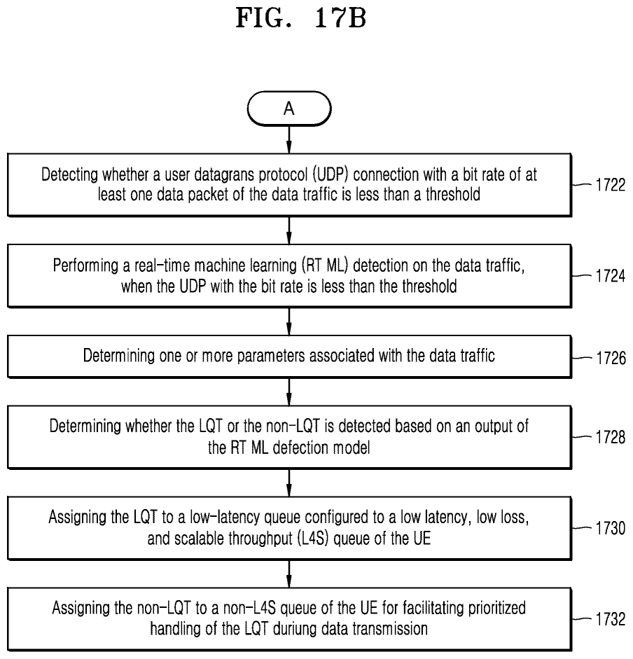

FIGS. 17A and 17B are flow diagrams that illustrates a method managing L4S capabilities of the UE (502) for data transmission according to various embodiments of the disclosure.

The method includes operations 1702 to 1732. Each operation is explained in further detail below.

At operation 1702, the UE (502) receives data traffic generated by at least one application running on the UE (502). For example, the applications running on the UE (502) may include, but not limited to a cloud gaming application, a VR/XR service, online gaming, video calling, and the like. Data traffic denotes the movement of data within a network, including both the internet and private networks. It is typically quantified in terms of data volume (like bits or bytes) over a specific time frame and can fluctuate based on various factors, including the nature of the activities being conducted, the number of users, and the speed of the data connection. Effective management of data traffic is crucial for maintaining optimal network performance, as it helps prevent issues such as slowdowns, disconnections, and congestion.

At operation 1704, the UE (502) loads pL4S interface (510) implemented on (or implemented as) an LAS receiver. For instance, the pL4S interface (510) is implemented as an extended Berkeley Packet Filter (eBPF) without requiring modifications to a kernel of the UE (502). L4S is widely discussed in the IETF and 3GPP standards. eBPF is a technology that enables the execution of functions within the kernel without the need for source code alterations or the incorporation of new components. Its ability to manage data packets in real-time makes it valuable for applications such as network analysis, security enforcement, and traffic management.

At operation 1706, the UE (502) captures incoming packets corresponding to the data traffic from the application(s) at ingress points of the UE (502) using the eBPF. This facilitates congestion feedback and protocol negotiation directly from the data plane of the User Equipment (UE) (502). The ingress points denote the locations or interfaces where packets enter the UE (502). These ingress points are important for managing data traffic and ensuring uninterrupted connectivity within the wireless network.

At operation 1708, the UE (502) determines predefined characteristics relating to the data traffic generated by the application(s). For instance, the predefined characteristics relating to the data traffic includes a past L4S history of the UE (502), packet characteristics of packets received from the application(s), an inter arrival time of the data traffic generated by the application(s), a packet size of the data traffic, a packet bitrate of the data traffic, an incoming to outgoing ratio of the data traffic, and a L3/L4 information. The L3/L4 information includes an IP addresses of the UE (502), ports of the UE (502), and protocols used by the UE (502).

The past L4S data associated with the UE (502) pertains to its interactions with an LAS-enabled network. This past data may encompass details regarding prior L4S network conditions, including latency, packet loss, and throughput experienced by the UE (502). Packet characteristics denote the specific features or attributes of the data packets transmitted by the UE (502). These characteristics may include aspects such as packet size, data type, and priority level. Additionally, the inter-arrival time of data traffic indicates the time interval between the arrival of successive data packets. Monitoring this inter-arrival time is important, as it significantly influences latency and jitter.

The size of data packets in traffic refers to the volume of data (measured in bytes) contained within each packet. In the context of L4S, this packet size can significantly affect congestion control, latency, and overall throughput. The packet bitrate indicates the speed (measured in bits per second, or bps) at which data packets are sent from the User Equipment (UE) (502). This bitrate plays a crucial role in determining the bandwidth requirements for the UE (502) and can influence network congestion levels. Additionally, the incoming to outgoing ratio represents the relationship between the volume of incoming data traffic received by the UE (502) and the outgoing traffic it transmits. This ratio is vital for effective traffic shaping and maintaining a high quality of service (QOS).

The information at layer 3 (L3), also known as the network layer, encompasses details regarding IP address routing and packet forwarding. It is responsible for facilitating data transfer between nodes across various networks. Meanwhile, layer 4 (L4), or the transport layer, pertains to transport protocols such as the Transmission Control Protocol (TCP) and the User Datagram Protocol (UDP). L4 plays a crucial role in ensuring reliable data transmission, managing flow control, and addressing congestion control. Together, the L3 and L4 information significantly influence the performance of the User Equipment (UE) in an L4S-enabled network. This interaction affects the transmission, management, and optimization of data traffic, aiming to achieve objectives such as low latency, reduced packet loss, and enhanced scalability.

At operation 1710, the UE (502) determines whether the data traffic generated by the application(s) is a low-queuing traffic (LQT) or a non-LQT based on the predefined characteristics. LQT denotes data traffic that is highly sensitive to latency and queuing delays. This type of traffic is important for applications demanding real-time communication or minimal latency, including voice over IP (VOIP), online gaming, and video conferencing. In contrast, non-LQT describes data traffic that is less affected by latency and queuing delays, allowing for some queuing and increased delays without major impacts on performance. Classifying data traffic as either LQT or non-LQT is crucial for ensuring low latency, minimal loss, and scalable throughput in L4S environments.

At operation 1712, the UE (502) sets explicit congestion notification (ECN) bits of the IP header (for example, IPV4, IPV6) of the data packets of the data traffic to 01 and flags of an ACE to 111 to indicate support for accurate explicit congestion notification (AccECN). The ACE functions as a 3-bit counter (ranging from 0 to 8) that tracks the number of CE packets contained within the data packets. Utilizing the ACE allows for appropriate adjustments to the sending rate, thereby preventing the accumulation of queues. The AccECN plays a vital role in the L4S framework, where achieving low latency and scalable throughput is crucial. The precise feedback and support provided by the AccECN facilitate the maintenance of minimal queuing delays and the prevention of network congestion, enabling the L4S to achieve its performance objectives.

At operation 1714, the UE (502) determines whether the data packet(s) received support AccECN. This determination is performed when the ECN bits of the IP header of the data packet(s) are set to 01 and the flags of the ACE are set to 111. At operation 1716, the UE (502) classifies the data packet(s) as the LQT when the AccECN is supported. At operation 1718, the UE (502) classifies the data packet(s) as the non-LQT when the AccECN is not supported.

At operation 1720, the UE (502) stores values of the ECN bits of the IP header of the data packet(s) received and the flags of the ACE in a hash map. The hash map organizes data in the form of key-value pairs, allowing for the addition, retrieval, and deletion of values through their corresponding keys. This method of storing data facilitates rapid access without the need for external resources.

At operation 1722, the UE (502) detects whether the UDP connection with a bit rate of the data packet(s) of the data traffic is less than a threshold. The UDP protocol operates as a connectionless system, meaning it does not create a formal link between the UE (502) or the sender (208) and the receiver (202). It transmits data packets, known as datagrams, to the receiver (202) without guaranteeing their arrival in any specific sequence.

At operation 1724, the UE (502) performs a real-time machine learning (RT ML) detection on the data traffic when the UDP with the bit rate is less than the threshold. The RT ML detection refers to a process of analyzing the data traffic in real-time to detect patterns, anomalies, or certain behaviors as data is transmitted to/from the UE (502). The RT ML is capable of handling large amounts of data traffic, making it useful for environments like cloud networks or large enterprises.

At operation 1726, the UE (502) determines one or more parameters associated with the data traffic. The one or more parameters are provided as inputs to train a RT ML detection model. For instance, the one or more parameters include an average inter-arrival time (IAT), a maximum IAT, a packet count, an average packet size, a minimum packet size, and a maximum packet size in uplink and downlink directions. In the proposed solution, the RT detector service operates at the framework layer, utilizing an AI/ML-driven intelligent solution to forecast traffic as either real-time or non-real time through machine learning techniques.

The average inter-arrival time (IAT) denotes the mean duration between successive data packets reaching a designated point within the L4S framework. This metric is instrumental in analyzing data traffic patterns and detecting congestion. Conversely, the maximum IAT signifies the longest duration recorded between two consecutive data packets, serving as an indicator of low traffic periods or possible complications within the L4S. The packet count represents the cumulative number of packets sent in either the uplink or downlink direction during a defined time interval.

The average packet size is defined as the mean size of packets sent over a designated time frame. This metric is useful for analyzing the characteristics of data traffic. The minimum packet size denotes the smallest packet size observed, which may suggest the existence of small control packets or headers. Conversely, the maximum packet size indicates the largest packet size recorded, potentially reflecting substantial data transfers, such as file uploads or video streaming. Subsequently, the UE (502) assesses whether LQT or non-LQT is identified based on the results from the RT ML detection model at operation 1728.

At operation 1730, the UE (502) assigns the LQT to the L4S queue. The L4S queue is configured to support low latency, low loss, and scalable throughput (L4S) capabilities. At operation 1732, the UE (502) assigns the non-LQT to a non-LAS queue. This facilitates prioritized handling of the LQT during data transmission.

In an embodiment, a non-transitory computer-readable storage medium may store one or more instructions. When executed by at least one processor individually or collectively, the one or more instructions may cause the at least one processor to perform one or more methods (or one or more combinations of one or more operations, steps, or functorialities) described herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing low latency low loss scalable throughput (L4S) capabilities of a user equipment (UE) for data transmission, the method comprising:
receiving, by the UE, data traffic generated by at least one application running on the UE;
identifying, by the UE, predefined characteristics relating to the data traffic generated by the at least one application;
determining, by the UE, whether the data traffic generated by the at least one application is a low-queuing traffic (LQT) or a non-LQT based on the predefined characteristics;
assigning, by the UE, the LQT to a low-latency queue configured to a LAS queue of the UE, wherein the L4S queue is configured to support LAS capabilities; and
assigning, by the UE, the non-LQT to a non-L4S queue of the UE for facilitating prioritized handling of the LQT during data transmission.

2. The method as claimed in claim 1, comprising:
prioritizing, by the UE, transmission of the LQT assigned to the L4S queue over the non-LQT assigned to the non-L4S queue.

3. The method as claimed in claim 2, wherein the LQT and the non-LQT are transmitted in accordance with accurate explicit congestion notification (AccECN) request for comments (RFC) specifications from egress points of the UE.

4. The method as claimed in claim 1, wherein the predefined characteristics relating to the data traffic comprises at least one of a past L4S history of the UE, a plurality of packet characteristics of packets received from the at least one application, an inter arrival time of the data traffic generated by the at least one application, a packet size of the data traffic, a packet bitrate of the data traffic, an incoming to outgoing ratio of the data traffic, or a layer 3 (L3)/layer 4 (L4) information including at least one of an Internet protocol (IP) addresses of the UE, ports of the UE, or protocols used by the UE.

5. The method as claimed in claim 1, wherein the receiving, by the UE, data traffic generated by at least one application running on the UE comprises:
loading, by the UE, a pluggable L4S (pL4S) interface, wherein the pL4S interface is implemented as an extended Berkeley Packet Filter (eBPF); and
capturing, by the UE, incoming packets corresponding to the data traffic from the at least one application at ingress points of the UE using the eBPF.

6. The method as claimed in claim 1, wherein the determining, by the UE, whether the data traffic generated is the LQT or the non-LQT based on the predefined characteristics comprises:
setting, by the UE, explicit congestion notification (ECN) bits of an IP header of one or more data packets of the data traffic to 01 and flags of an Accurate ECN (ACE) to 111 to indicate support for accurate explicit congestion notification (AccECN);
determining, by the UE, whether at least one data packet of a plurality of data packets received support AccECN, in response to the ECN bits of the IP header of at least one data packet of the one or more data packets being set to 01 and the flags of the ACE being set to 111; and
performing, by the UE, one of:
classifying the at least one data packet of the one or more data packets as the LQT in response to AccECN being supported, or
classifying the at least one data packet of the one or more data packets as the non-LQT in response to AccECN not being supported.

7. The method as claimed in claim 6, comprising:
storing, by the UE, values of the ECN bits of the IP header of at least one data packet of the one or more data packets received and the flags of the ACE in a hash map.

8. The method as claimed in claim 7, wherein the ACE corresponds to a counter that counts a number of Congestion Experienced (CE) packets within the one or more data packets, and
wherein, for outgoing acknowledgment (ACK) packets, an ACE field within a transmission control protocol (TCP) header of the ACK packet is modified in accordance with the CE packet count recorded in the hash map.

9. The method as claimed in claim 1,
wherein the determining, by the UE, whether the data traffic generated is the LQT or the non-LQT based on the predefined characteristics comprises:
detecting, by the UE, whether a user datagram protocol (UDP) connection with a bit rate of at least one data packet of the data traffic is less than a threshold; and
performing, by the UE, a real-time machine learning (RT ML) detection on the data traffic, in response to the UDP with the bit rate being less than the threshold, and
wherein the RT ML detection comprises:
determining, by the UE, one or more parameters associated with the data traffic, wherein the one or more parameters are provided as inputs to train a RT ML detection model, and wherein the one or more parameters comprise at least one of an average inter-arrival time (IAT), a maximum IAT, a packet count, an average packet size, a minimum packet size, or a maximum packet size in uplink and downlink directions, and
determining, by the UE, whether the LQT or the non-LQT is detected based on an output of the RT ML detection model.

10. A user equipment (UE) for managing low latency low loss scalable throughput (L4S) capabilities for data transmission, the UE comprising:
a processor including processing circuitry;
memory including one or more storage media;
a pluggable L4S (pL4S) interface, wherein the pL4S interface intercepts and manipulates packet flows of data traffic at the UE; and
a pL4S throughput controller communicatively coupled to the processor and the memory,
wherein the pL4S throughput controller is configured to:
receive data traffic generated by at least one application running on the UE,
identify predefined characteristics relating to the data traffic generated by the at least one application,
determine whether the data traffic generated by the at least one application is a low-queuing traffic (LQT) or a non-LQT based on the predefined characteristics,
assign the LQT to a low-latency queue configured to a LAS queue of the UE, wherein the L4S queue is configured to support L4S capabilities, and
assign the non-LQT to a non-L4S queue of the UE for facilitating prioritized handling of the LQT during data transmission.

11. The UE as claimed in claim 10, wherein the pL4S throughput controller is further configured to prioritize transmission of the LQT assigned to the L4S queue over the non-LQT assigned to the non-LAS queue.

12. The UE as claimed in claim 11, wherein the LQT and the non-LQT are transmitted in accordance with accurate explicit congestion notification (AccECN) request for comments (RFC) specifications from egress points of the UE.

13. The UE as claimed in claim 10, wherein the predefined characteristics relating to the data traffic comprises at least one of a past L4S history of the UE, a plurality of packet characteristics of packets received from the at least one application, an inter arrival time of the data traffic generated by the at least one application, a packet size of the data traffic, a packet bitrate of the data traffic, an incoming to outgoing ratio of the data traffic, or a layer 3 (L3)/layer 4 (L4) information including at least one of an Internet protocol (IP) addresses of the UE, ports of the UE, or protocols used by the UE.

14. The UE as claimed in claim 10, wherein the pL4S throughput controller is further configured to:
load the pL4S interface, wherein the pL4S interface is implemented as an extended Berkeley Packet Filter (eBPF); and
capture incoming packets corresponding to the data traffic from the at least one application at ingress points of the UE using the eBPF.

15. The UE as claimed in claim 10, wherein the pL4S throughput controller is further configured to:
set explicit congestion notification (ECN) bits of an IP header of one or more data packets of the data traffic to 01 and flags of an Accurate ECN (ACE) to 111 to indicate support for AccECN;
determine whether at least one data packet of a plurality of data packets received support AccECN, in response to the ECN bits of the IP header of at least one data packet of the one or more data packets being set to 01 and the flags of the ACE being set to 111; and
perform one of:
classify the at least one data packet of the one or more data packets as the LQT in response to AccECN being supported, or
classify the at least one data packet of the one or more data packets as the non-LQT in response to AccECN not being supported.

16. The UE as claimed in claim 15, wherein the pL4S throughput controller is further configured to:
store values of the ECN bits of the IP header of at least one data packet of the one or more data packets received and the flags of the ACE in a hash map.

17. The UE as claimed in claim 16, wherein the ACE corresponds to a counter that counts a number of Congestion Experienced (CE) packets within the one or more data packets.

18. The UE as claimed in claim 17, wherein, for outgoing acknowledgment (ACK) packets, an ACE field within a transmission control protocol (TCP) header of the ACK packet is modified in accordance with the CE packet count recorded in the hash map.

19. The UE as claimed in claim 10,
wherein the pL4S throughput controller is further configured to:
detect whether a user datagram protocol (UDP) connection with a bit rate of at least one data packet of the data traffic is less than a threshold; and
perform a real-time machine learning (RT ML) detection on the data traffic, in response to the UDP with the bit rate being less than the threshold, and wherein the RT ML detection is configured to:
determine one or more parameters associated with the data traffic, wherein the one or more parameters are provided as inputs to train a RT ML detection model, and wherein the one or more parameters comprise at least one of an average inter-arrival time (IAT), a maximum IAT, a packet count, an average packet size, a minimum packet size, or a maximum packet size in uplink and downlink directions, and
determine whether the LQT or the non-LQT is detected based on an output of the RT ML detection model.

20. A non-transitory computer-readable storage medium storing one or more instructions, wherein the one or more instructions, when executed by at least one processor, cause the at least one processor to perform the method of claim 1.
